(19) United States
(12) Patent Application Publication
(10) Pub. No.: US 2009/0025364 A1
(43) Pub. Date: Jan. 29, 2009

(54) Multi-Stage Compressor, Air-Separating Apparatus Comprising Such a Compressor, and Installation

(75) Inventor: Bernard Darredeau, Sartrouville (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude et I'Exploitation Des Procedes Georges Claude, Paris (FR)

(21) Appl. No.: 12/282,209

(22) PCT Filed: Mar. 5, 2007
(86) PCT No.: PCT/FR2007/050878

§ 371 Date: Sep. 9, 2008

(30) Foreign Application Priority Data
Mar. 14, 2006 (FR) 0650863

(51) Int. Cl. F02C 3/06; F04D 19/02

(52) U.S. Cl. 60/39.15; 60/772; 415/169.1

(57) ABSTRACT

A multi-stage compressor, for an air separation unit comprising such a compressor and to an installation is provided.

The present invention relates to a multi-stage compressor, to an air separation unit comprising such a compressor and to an installation.

In an IGCC power production method using oxygen in the gassifier, it is possible to opt to use some of the air compressed in the gas turbine compressor to supply the air separation unit (ASU) that feeds oxygen to the gassifier.

This arrangement is used in order to adapt the operation of the gas turbine which is generally designed to burn a gas of a higher calorific value than the gas generated by the gassifier.

The pressure of the air taken from the gas turbine is generally higher than that normally used in the ASU. In order to avoid any loss of power, it is advantageous for this air to be used in the ASU at the pressure at which it is available. When this air is going to form just part of the supply to the ASU, the remaining air needed has to be compressed in an independent compressor. It would be preferable for this second air flow rate to be compressed to the same pressure as the air flow rate from the gas turbine compressor so that the method will not be dependent on the proportion of air taken from the gas turbine, it being possible for this proportion to vary at any time.

A problem that is generally encountered on IGCCs then arises. This is how to reduce the charge of air, which needs to be able to be reduced down to 50% of the nominal charge, with a simultaneous reduction in the pressure of the air compressed in the gas turbine, this reduction again being by about 50%.

The independent air compressor supplying the ASU is therefore subject to a reduction in flow rate which may be as much as 50 or 60% (if an increase in the proportion of air extracted is added to the reduction in flow rate of the ASU). In addition, the pressure of this air compressed in the independent compressor needs to be reduced by about 50%.

The conventional approach is to reduce the flow rate of a compressor to a certain extent using internal regulating systems, for example moving vanes on the inlet side of the stages. In order to effect a substantial reduction in flow rate, it might be possible to conceive of using moving vanes on the inlet side of all the stages. In that way, one might expect to be able to reduce the flow rate to 70% of the nominal flow rate without any reduction in the delivery-side pressure. Loss in efficiency would be 5 to 10% and the air would then have to have its pressure reduced to the required pressure. Even assuming that the efficiency of the impellers was not reduced with respect to the nominal efficiency, the power consumption would still be 70% of the nominal even though only 50% of the nominal flow rate need be compressed to a very low pressure. If there is a desire to reduce the pressure on the delivery side of each stage, then the characteristic of compressor impellers is such that this would result in an increase in flow rate, which means that the moving vanes would need to have an even more far-ranging effect, resulting in an even greater loss of efficiency. In the solution according to the invention, 20% of the nominal flow rate is therefore vented to the open air, and the compressed air is throttled to reduce its pressure down to the required pressure.

One aspect of the invention is to provide a compressor comprising a first and a second stage mounted on a common axis with means for supplying the first stage with a gas that is to be compressed, means for transferring the compressed gas from the delivery side of the first stage to the inlet side of the second stage and means for producing a pressurized gas on the delivery side of the second stage, characterized in that it comprises a throttle valve for reducing the pressure of the compressed gas downstream of the delivery side of the first stage and upstream of the inlet side of the second stage, means for sending the compressed gas from the delivery side of the first stage to the inlet side of the second stage via the throttle valve, and means for venting some of the gas compressed in the first stage to the open air.

Optionally:
the compressor comprises a third stage, means for transferring the pressurized gas from the delivery side of the second stage to the inlet side of the third stage, a throttle valve for reducing the pressure of the compressed gas downstream of the delivery side of the second stage and upstream of the inlet side of the third stage, and means for venting some of the gas compressed in the second stage to the open air.
the first stage has flow-regulating moving vanes.
the compressor comprises at least one stage downstream of the third but no pressure-reducing means between the delivery side of the third stage and the stage(s) downstream of the third.
the throttle valve is located upstream one stage of the compressor and upstream or downstream of a cooler designed to cool the air intended for that stage.

Another aspect of the invention is to provide an air separation unit that employs cryogenic distillation, comprising at least one compressor as described hereinabove.

Another aspect of the invention is to provide an installation comprising a first air compressor, a combustion chamber, a gas turbine, means for sending air from the first air compressor to the combustion chamber, means for sending combustion gases to the gas turbine, an air separation unit, means for sending air from the first air compressor to the air separation unit, a second compressor and means for sending air from the second air compressor to the air separation unit, characterized in that the second compressor is as described hereinabove.

Another aspect of the invention is to provide an integrated method for producing power and one of the gases in the air, in which air is compressed in a first air compressor to a first pressure, some of the air from the first compressor is sent to a combustion chamber, combustion gases are sent to a gas turbine, some of the air from the first compressor is sent to an air separation unit, air is compressed in a second compressor to the first pressure and sent to the air separation unit, the second compressor comprising at least two stages, and in which, in order to compress a nominal flow rate to the first pressure intended for the air separation unit, air is sent from a first stage of the second compressor to a second stage thereof, characterized in that, in order to produce a reduced flow rate at a reduced pressure intended for the air separation unit, some of the air compressed in the first stage is vented to the open air and the pressure of the remaining air from the first stage is reduced in a throttle valve upstream of the second stage.

As a possibility:
the second compressor comprises at least three stages and, in order to compress a nominal flow rate to the first pressure intended for the air separation unit, the air is sent from a second stage of the second compressor to a third stage thereof, characterized in that, in order to produce a reduced flow rate at a reduced pressure intended for the air separation unit, some of the air compressed in the first stage is vented to the open air and the pressure of the remaining air from the second stage is reduced in a throttle valve upstream of the third stage.
the volumetric flow rate of the compressed air on the inlet side and/or on the delivery side of the second (and third) stage(s) is substantially constant between nominal operation and de-rated operation.

The solution proposed by the invention is to add a throttle valve to the inlet side of the second compression stage and, if necessary, to the inlet side of the third and subsequent stages. This valve has the effect of reducing the intake pressure of the next stage so that, if its compression ratio is maintained and its delivery pressure reduced by the same proportion as the intake pressure, its volumetric flow rate will be maintained but its mass flow rate will be reduced in the same proportion as its inlet pressure. By maintaining the nominal compression ratios of the subsequent stages, i.e. by reducing the pressures in the same proportions, the same reduction in flow rate will be achieved in all these stages with no loss of efficiency because all these stages will operate practically at their nominal point. There is thus obtained, for all the stages after the throttle valve, a flow rate that is reduced with a delivery pressure that is reduced and a power that is reduced all in the same proportions, without any loss of efficiency.

The invention will be described in greater detail with reference to the figures in which:

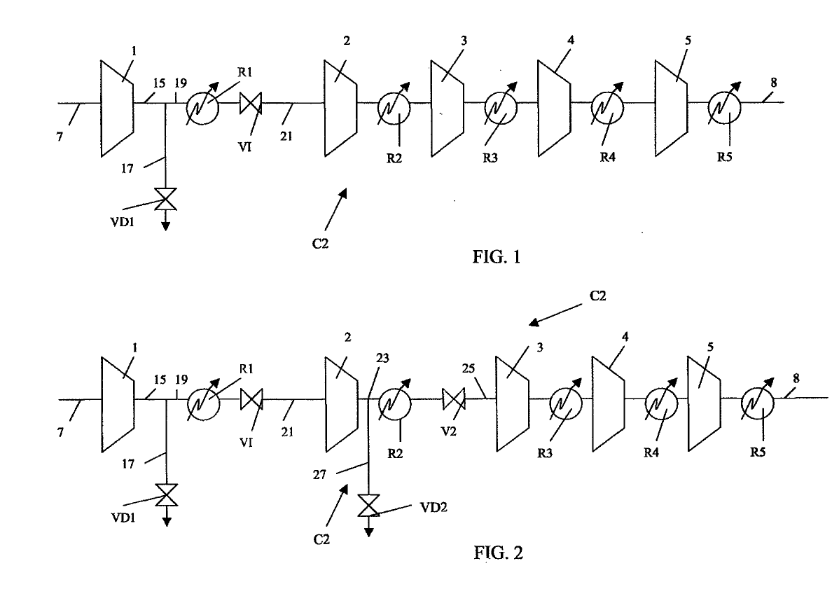

FIGS. 1 and 2 show a compressor according to the invention;

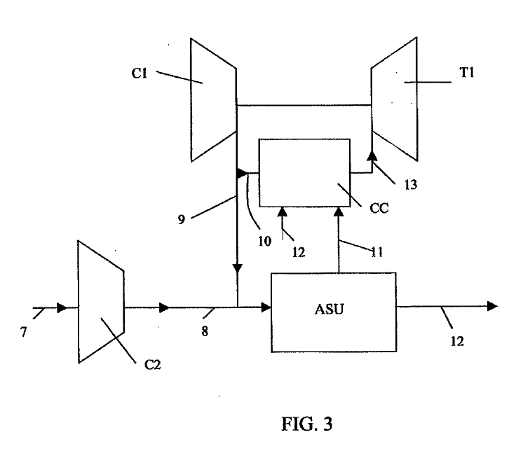

FIG. 3 shows an installation according to the invention.

FIG. 1 illustrates a compressor C2 with five stages 1, 2, 3, 4, 5 on the same axis and with a cooling means between each stage and downstream of the last stage, R1, R2, R3, R4, R5. The air 7 is sent to a first stage 1 which has flow-regulating moving vanes.

During nominal operation, the vanes of the stage 1 do not reduce the flow rate, and all of the air compressed in the first stage 1 enters the pipes 15, 19, 21 passing through a throttle valve V1 with no reduction in pressure. The flow rate is then compressed in the stages 2, 3, 4 and 5.

In de-rated operation, the vanes of the first stage 1 reduce the flow rate of the air 7 to 70% of the nominal flow rate. A flow rate representing 12.2% of the nominal flow rate is vented to the open air through the pipe 17 and the pressure-reducing valve VD1. The remainder of the air, which represents 57.8% of the nominal flow rate, is sent to the cooler R1 and then to the throttle valve which reduces its pressure to 57.8% of the nominal pressure value. This reduced-pressure flow rate is sent through the pipe 21 to the inlet side of the second stage 2. The flow rate is then compressed in the stages 2, 3, 4 and 5 without undergoing any reduction in pressure between two adjacent stages apart from the pressure reduction due to pressure drops through the coolers R2, R3, R4 and R5. The final air pressure will be 8.9 bar.

For each given point of the compressor, the volumetric flow rate remains substantially constant between nominal operation and de-rated operation.

FIG. 2 illustrates another compressor C2 with five stages 1, 2, 3, 4, 5 with a cooling means between each stage and downstream of the last stage, R1, R2, R3, R4, R5. The air 7 is sent to a first stage 1 which has flow-regulating moving vanes.

In nominal operation, the vanes of the stage 1 do not reduce the flow rate, and all of the air compressed in the first stage 1 enters the pipes 15, 19, 21 via a throttle valve V1 with no reduction in pressure. Downstream of the second stage 2 it is cooled by the cooler R2 and then passes through the throttle valve V2 without having its pressure reduced. The flow rate is then compressed in the stages 3, 4 and 5.

In de-rated operation, the vanes of the stage 1 reduce the flow rate of the air 7 to 70% of the nominal flow rate. A flow rate representing 12.2% of the nominal flow rate is vented to the open air through the pipe 17 and the pressure-reducing valve VD1. The remainder of the air, which represents 57.8% of the nominal flow rate is sent to the cooler R1 and then to the throttle valve which reduces its pressure to 57.8% of the nominal pressure. A reduced-pressure flow rate is sent through the pipe 21 to the inlet side of the second stage 2. This flow rate is compressed in the second stage and split into two. 6.3% of the nominal flow rate is vented to the open air through the pipe 27 and the pressure-reducing valve VD2, while the remainder of the air from the second stage is cooled by the cooler R2 and then has its pressure reduced by a second throttle valve V2 with a reduction in the flow rate down to 51.5% of the nominal flow rate and a reduction in pressure down to 51.5% of the nominal pressure. The flow rate is then compressed in the stages 3, 4 and 5 without undergoing any reduction in pressure between two adjacent stages apart from the reduction in pressure due to pressure drops through the coolers R3, R4 and R5. The final air pressure will be 8.04 bar.

For each given point of the compressor, the volumetric flow rate remains substantially constant between nominal operation and de-rated operation.

In FIG. 3, air is compressed in the adiabatic compressor C1 and split into two. Some 9 is cooled (not illustrated) and sent to an air separation unit ASU. Some, 10, is sent to a combustion chamber CC to be burnt with a fuel 12, such as natural gas or coal. The combustion gases 13 are expanded to a reduced pressure in a turbine T1 coupled to the compressor C1. The air separation unit is also supplied with air 8 by a compressor C2 according to the invention, which may be as described with reference to FIGS. 1 and 2. Nitrogen 11 from the air separation unit may possibly be sent to the gas turbine and the air separation unit also produces oxygen 12 for a gassifier.

One example of the advantage afforded by this means of simultaneously reducing mass flow rate and pressure can be found herein.

Let us assume a nominal flow rate of 100 Nm³/h and a nominal delivery pressure of 16 atm abs, and a five-stage compressor.

The power of each stage is evaluated as being equal to the product 0.1×log(P_{ref}/Pₐₛₚ)×flow rate, P_{ref} being the delivery pressure and Pₐₛₚ the intake pressure, which gives a realistic value in kW and the power of the compressor is taken to be the sum of the powers of the stages.

In the de-rated scenario, it is assumed that the flow rate is 50 Nm³/h and the required delivery pressure is 8 atm abs.

Had the efficiency been preserved, the power consumed would have been equal approximately to 0.5×log(8)/log(16)=37.5% of the nominal power.

In the attached table, the first de-rated scenario shows the power obtained using moving vanes on each stage, assuming (very optimistically) that such a measure will be capable of reducing the mass flow rate down to 70% with no loss in efficiency.

The second de-rated scenario shows the use of moving vanes only on the first stage and of a throttle valve on the intake side of the second stage, thus a compressor according to the invention. In this example, this solution is not enough to reduce the pressure and flow rate down to the desired value, but about 14% is saved in terms of power consumption over the solution that employs only moving vanes.

In the third de-rated scenario, use is made of a compressor according to the invention and, by comparison with scenario 2, a valve is added to the intake side of the third stage, allowing the delivery pressure and flow rate to be reduced still further on the subsequent stages. The reduction in power with respect to the basic scenario is approximately 20%.

This invention claims, for a multi-stage compressor subjected to simultaneous reductions in mass flow rate and delivery pressure in excess of 25%, the use of a throttle valve on the intake side of the second stage and, if necessary, of the subsequent stage(s).

| | | | | | | Rela- |
|---|---|---|---|---|---|---|
| | | | | | | tive |
| Stage | | | | | | pow- |
| 1 | 2 | 3 | 4 | 5 | Power | er |

Nominal

| | | | | | | | |
|---|---|---|---|---|---|---|---|
| Pₐₛₚ | 1 | 1.73 | 2.99 | 5.19 | 9.07 | | |
| P_{ref} | 1.78 | 3.06 | 5.29 | 9.19 | 16.05 | | |
| Mass | 100 | 100 | 100 | 100 | 100 | | |
| flow | | | | | | | |
| rate | | | | | | | |
| Power | 2.5 | 2.48 | 2.48 | 2.48 | 2.48 | 12.42 | 100 |

De-rated with moving vanes

| | | | | | | | |
|---|---|---|---|---|---|---|---|
| Pₐₛₚ | 1 | 1.73 | 2.99 | 5.19 | 9.07 | | |
| P_{ref} | 1.78 | 3.06 | 5.29 | 9.19 | 16.05 | | |
| Mass | 70 | 70 | 70 | 70 | 70 | | |
| flow | | | | | | | |
| rate | | | | | | | |
| Power | 1.75 | 7.73 | 7.73 | 1.74 | 1.74 | 8.69 | 70 |

De-rated with vanes on the 1st stage and throttle valve V1
on the intake side of the 2nd stage (FIG. 1)

| | | | | | | | |
|---|---|---|---|---|---|---|---|
| Pₐₛₚ | 1 | 1 | 1.7 | 2.91 | 5.03 | | |
| P_{ref} | 1.78 | 1.77 | 3.01 | 5.15 | 8.9 | | |
| Mass | 70 | 57.8 | 57.8 | 57.8 | 57.8 | | |
| flow | | | | | | | |
| rate | | | | | | | |
| Power | 1.75 | 1.43 | 1.43 | 1.43 | 1.43 | 7.47 | 60.1 |

De-rated with vanes on the 1st stage and throttle valves V1
and V2 on the intake side of the 2nd and 3rd stages (FIG. 2)

| | | | | | | | |
|---|---|---|---|---|---|---|---|
| Pₐₛₚ | 1 | 1 | 1.54 | 2.63 | 4.54 | | |
| P_{ref} | 1.78 | 1.77 | 2.73 | 4.66 | 8.04 | | |
| Mass | 70 | 57.8 | 51.5 | 51.5 | 51.5 | | |
| flow | | | | | | | |
| rate | | | | | | | |
| Power | 1.75 | 1.43 | 1.28 | 1.28 | 1.28 | 7.02 | 56.5 |

1-10. (canceled)

11. A compressor comprising a first and a second stage mounted on a common axis comprising;
a means for supplying the first stage with a gas that is to be compressed,
means for sending the compressed gas from the delivery side of the first stage to the inlet side of the second stage via the throttle valve,
means for venting some of the gas compressed in the first stage to the open air;
a throttle valve for reducing the pressure of the compressed gas downstream of the delivery side of the first stage and upstream of the inlet side of the second stage, and
means for producing a pressurized gas on the delivery side of the second stage.

12. The compressor as claimed in claim 11, comprising;
a third stage;
means for transferring the pressurized gas from the delivery side of the second stage to the inlet side of the third stage,
a throttle valve for reducing the pressure of the compressed gas downstream of the delivery side of the second stage and upstream of the inlet side of the third stage, and
means for venting some of the gas compressed in the second stage to the open air.

13. The compressor of claim 11, in which the first stage has flow-regulating moving vanes.

14. The compressor of claim 11, comprising a stage immediately downstream of the third but no pressure-reducing means between the delivery side of the third stage and the stage immediately downstream of the third.

15. The compressor of claim 11, in which the throttle valve is located upstream of one stage of the compressor and upstream or downstream of a cooler designed to cool the air intended for that stage.

16. An air separation unit that employs cryogenic distillation, comprising at least one compressor as claimed in claim 11.

17. An installation comprising;
a first air compressor;
a combustion chamber;
a gas turbine;
means for sending air from the first air compressor to the combustion chamber;
means for sending combustion gases to the gas turbine;
an air separation unit;
means for sending air from the first air compressor to the air separation unit;
a second compressor, and;
means for sending air from the second air compressor to the air separation unit, wherein the second compressor is as claimed in claim 11.

18. An integrated method for producing power and one of the gases in the air, comprising;
compressing air in a first air compressor to a first pressure,
sending at least part of the air from the first compressor to a combustion chamber;
sending the resulting combustion gases to a gas turbine;
sending at least part of the air from the first compressor to an air separation unit;
compressing air in a second compressor to the first pressure;
sending at least part of the air from the second compressor to the air separation unit, wherein the second compressor comprises at least two stages, and
in which, in order to compress a nominal flow rate to the first pressure intended for the air separation unit, air is sent from a first stage of the second compressor to a second stage thereof, wherein, in order to produce a reduced flow rate at a reduced pressure intended for the air separation unit, some of the air compressed in the first stage is vented to the open air and the pressure of the remaining air from the first stage is reduced in a throttle valve upstream of the second stage.

19. The method as claimed in claim 18, in which the second compressor comprises at least three stages and, in order to compress a nominal flow rate to the first pressure intended for the air separation unit, the air is sent from a second stage of the second compressor to a third stage thereof, wherein, in order to produce a reduced flow rate at a reduced pressure intended for the air separation unit, some of the air compressed in the second stage is vented to the open air and the pressure of the remaining air from the second stage is reduced in a throttle valve upstream of the third stage.

20. The method of claim 18, in which the volumetric flow rate of the compressed air on the inlet side and/or on the delivery side of the second (and third) stage(s) is substantially constant between nominal operation and de-rated operation.
